(19) United States
(12) Patent Application Publication
(10) Pub. No.: US 2021/0287295 A1
(43) Pub. Date: Sep. 16, 2021

(54) METHOD AND APPARATUS FOR RECOMMENDING FINANCIAL PRODUCT, ELECTRONIC DEVICE, AND COMPUTER STORAGE MEDIUM

(71) Applicant: Tencent Technology (Shenzhen) Company Limited, Shenzhen (CN)

(72) Inventors: Fan YANG, Shenzhen (CN); Fei Huang, Shenzhen (CN)

(21) Appl. No.: 17/337,284

(22) Filed: Jun. 2, 2021

Related U.S. Application Data
(63) Continuation of application No. PCT/CN2020/093503, filed on May 29, 2020.

(30) Foreign Application Priority Data
Jun. 6, 2019 (CN) 201910490545.8

(51) Int. Cl. G06Q 40/06

(52) U.S. Cl. CPC G06Q 40/06

(57) ABSTRACT

This application discloses a method for recommending a financial product performed at a server. The method includes: receiving, from a client, a request to recommend the financial product; constructing M categories of product recommendation features of each of N financial products according to historical data of a set of parameters of the financial product, N and M being both positive integers; obtaining, for each of the M categories of product recommendation features, a comprehensive product recommendation feature corresponding to the category; determining a user recommendation proportion of the financial product according to deviations of the categories of product recommendation features of the financial product from the comprehensive product recommendation feature corresponding to the categories, the user recommendation proportion being a proportion of users to which the financial product is recommended to all users; and determining the recommended financial product according to user recommendation proportions of the financial products to the requesting client.

### CROSS-REFERENCE TO RELATED APPLICATIONS

This application is a continuation application of PCT Patent Application No. PCT/CN2020/093503, entitled “METHOD AND APPARATUS FOR RECOMMENDING FINANCIAL PRODUCT, ELECTRONIC DEVICE, AND COMPUTER STORAGE MEDIUM” filed on May 29, 2020, which claims priority to Chinese Patent Application No. 201910490545.8, entitled “METHOD AND APPARATUS FOR RECOMMENDING FINANCIAL PRODUCT, ELECTRONIC DEVICE, AND COMPUTER STORAGE MEDIUM” filed on Jun. 6, 2019, all of which are incorporated herein by reference in their entirety.

### FIELD OF THE TECHNOLOGY

This application relates to the field of computer technologies, and in particular, to a method, apparatus, and device for recommending a financial product, and a computer-readable storage medium.

### BACKGROUND OF THE DISCLOSURE

Online wealth management means that users independently choose suitable wealth management modes based on their own economic conditions through wealth management platforms on the Internet. As long as a network is available, users can find wealth management projects in which they are interested on the Internet anytime anywhere, and enjoy a brand new wealth management model at home.

For example, as an important way to obtain financial products, a plurality of financial products are provided on the wealth management platform to provide users with the categories of purchasing choices. These financial products may be from the same financial institution or different financial institutions. In order to avoid potential financial risks brought by an excessively high amount of a single product, it is necessary to limit an upper limit of purchasing a single financial product. In this way, different users need to be assigned to the financial product, that is, the financial product needs to be diverted to make different financial products correspond to different user groups.

In the related art, improper diversion affects stability of the wealth management platform and security of user data.

### SUMMARY

Embodiments of this application provide a method, apparatus, and device for recommending a financial product, and a computer-readable storage medium, which can determine a user recommendation proportion according to set parameters of financial products, so as to improve accuracy and stability of diverting the financial products, thereby ensuring security of user data.

An embodiment of this application provides a method for recommending a financial product. The method includes:

receiving, from a client, a request to recommend the financial product;

constructing M categories of product recommendation features of each of N financial products according to historical data of a set of parameters of the financial product, N and M being both positive integers;

obtaining, for each of the M categories of product recommendation features, a comprehensive product recommendation feature corresponding to the categories;

determining a user recommendation proportion of the financial product according to deviations of the categories of product recommendation features of the financial product from the comprehensive product recommendation feature corresponding to the categories, the user recommendation proportion being a proportion of users to which the financial product is recommended to all users; and

determining the recommended financial product according to user recommendation proportions of the financial products to the requesting client.

An embodiment of this application provides a method for recommending a financial product. The method is performed by a server. The server includes one or more processors and a memory, and one or more programs, the one or more programs being stored in the memory. The programs may include one or more units each corresponding to a set of instructions, and the one or more processors are configured to execute the instructions. The method includes:

receiving, from a client, a request to recommend the financial product;

constructing M categories of product recommendation features of each of N financial products according to historical data of a set of parameters of the financial product, N and M being both positive integers;

obtaining, for each of the M categories of product recommendation features, a comprehensive product recommendation feature corresponding to the categories;

determining a user recommendation proportion of the financial product according to deviations of the categories of product recommendation features of the financial product from the comprehensive product recommendation feature corresponding to the categories, the user recommendation proportion being a proportion of users to which the financial product is recommended to all users; and

determining the recommended financial product according to user recommendation proportions of the financial products to the requesting client.

An embodiment of this application provides an apparatus for recommending a financial product. The apparatus includes:

a feature construction unit configured to construct M categories of product recommendation features of each of N financial products according to historical data of a set of parameters of the financial product, N and M being both positive integers;

a feature combination unit configured to obtain, for each of the M categories of product recommendation features, a comprehensive product recommendation feature corresponding to the categories;

a recommendation proportion determination unit configured to determine a user recommendation proportion of the financial product according to deviations of the categories of product recommendation features of the financial product from the comprehensive product recommendation feature corresponding to the categories, the user recommendation proportion being a proportion of users to which the financial product is recommended to all users; and

a product recommendation unit configured to determine the recommended financial product according to user recommendation proportions of the financial products to the requesting client.

An embodiment of this application provides an electronic device, including a memory and a processor,

the memory being configured to store a computer program; and

the processor being configured to implement the method described in the foregoing aspect when executing the program.

An embodiment of this application provides a computer-readable storage medium storing instructions executable by a processor, the processor being configured to implement the method described in the foregoing aspect when executing the executable instructions.

In the embodiment of this application, a wealth management platform constructs product recommendation features based on the historical data of the set parameters of the financial products, obtains a comprehensive product recommendation feature of all of the financial products, then determines the user recommendation proportion of the financial product according to the deviations of the product recommendation features of the financial products from the comprehensive product recommendation feature corresponding to the categories, and finally recommends a financial product to a user based on user recommendation proportions of the financial products. Therefore, according to the parameters of the financial products, the user recommendation proportions related to the parameters of the financial products can be determined, which improves the accuracy of diverting the financial products, and the diversion of the financial products is not affected by non-self parameters, thereby improving stability of the wealth management platform and improving the security of user data.

### BRIEF DESCRIPTION OF THE DRAWINGS

FIG. 1A to FIG. 1B are schematic diagrams of application scenarios according to an embodiment of this application.

FIG. 2 is a schematic diagram of a display page of a wealth management platform according to an embodiment of this application.

FIG. 3 is a schematic flowchart of a method for recommending a financial product according to an embodiment of this application.

FIG. 4 is a schematic flowchart of a process of determining a user recommendation proportion according to an embodiment of this application.

FIG. 5 is a schematic flowchart of a process of determining a user recommendation proportion according to an embodiment of this application.

FIG. 6 is a schematic flowchart of a process of determining a user recommendation proportion according to an embodiment of this application.

FIG. 7 is a schematic flowchart of a process of determining a user recommendation proportion according to an embodiment of this application.

FIG. 8 is a schematic structural diagram of an apparatus for recommending a financial product according to an embodiment of this application.

FIG. 9 is a schematic structural diagram of an electronic device according to an embodiment of this application.

### DESCRIPTION OF EMBODIMENTS

To make the objectives, technical solutions, and advantages of this application clearer, the following clearly and completely describes the technical solutions in the embodiments of this application with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application. The embodiments in the application and features in the embodiments may be mutually combined in case that no conflict occurs. In addition, although a logic order is shown in the flowcharts, in some cases, the shown or described steps may be performed in an order different from the order herein.

To help understand the technical solutions provided in the embodiments of this application, some key items used in the embodiments of this application are explained herein first.

Financial product: A financial product refers to various carriers in a financing process, which includes currency, gold, foreign exchange, securities, and the like. Such financial products are objects for purchasing and selling in a financial market, and a supplier and a demander determine prices of financial products according to the principle of competition in the market, such as interest rates or yields, and finally complete a transaction to achieve the purpose of financing. In the embodiments of this application, the financial product generally refers to products that can be traded through Internet Finance. Internet Finance refers to a new financial transaction mode in which a traditional financial institution and an Internet enterprise use the Internet technology and information and communication technology to achieve financing, payment, investment, and information intermediary services, which is a new model and a new service created to adapt to new demands based on a technical level that can achieve a safe and mobile network. Circulation of Internet financial products is generally based on electronic money.

Wealth management platform: A wealth management platform may alternatively be referred to as a financial product platform, which is generally a platform provided by an Internet enterprise for users to purchase financial products, for example, transaction platforms of the categories of banks or transaction platforms provided by other wealth management institutions.

Traffic assignment: In the embodiment of this application, traffic refers to users in the wealth management platform. In the same wealth management platform, there are generally numerous financial products. In order to avoid potential financial risks caused by an excessive amount of a single financial product, an upper limit for purchasing a single wealth management product (financial product) may be set. Therefore, the wealth management platform usually needs to assign different users to a plurality of wealth management products, that is, needs to perform traffic assignment. For example, when there are 3 financial products, that is, A, B, and C, different user groups U₁, U₂, and U₃ need to be assigned to different financial products A, B, and C. Correspondingly, a financial product A is to be assigned to users in a user group U₁, a financial product B is to be assigned to users in a user group U₂, and a financial product C is to be assigned to users in a user group U₃. The purpose of the embodiments of this application is mainly to determine a proportion of a number of users in the user groups U₁, U₂, and U₃ to all users. The users in the user groups U₁, U₂, and U₃ may be completely different, or may be partially the same.

Blockchain: An encrypted chain transaction storage structure formed by blocks.

Blockchain network: A set of a series of nodes of a blockchain in which a new block is included through consensus.

In addition, the term “and/or” in this specification describes only an association relationship for describing associated objects and represents that three relationships may exist. For example, A and/or B may represent the following three cases: Only A exists, both A and B exist, and only B exists. In addition, if there is no special description, the character “/” in this specification usually indicates an “or” relationship between the associated objects.

In the related art, the wealth management platform usually performs traffic assignment in a manner of evenly assigning the traffic to a plurality of financial products, that is, proportions of users corresponding to the financial products to all of the users are the same. The financial products are recommended to the users according to the set proportions. However, due to certain differences in attribute values of different products, financial products have advantages and disadvantages for users. The manner of evenly assigning the traffic to the plurality of financial products prevents more users from being assigned to better financial products, which is obviously a poor experience for all of the users. Therefore, how to assign the traffic more effectively and achieve a high accuracy of recommending the financial product to the user is an urgent technical problem to be solved.

In view of the above problems, it is found in the embodiments of this application that just because the current traffic assignment method is direct even assignment, the user recommendation proportions of all of the financial products are the same, and characteristics of the financial products itself are not taken into consideration, some better financial products cannot get more traffic. Therefore, in order to solve the above problems, it is necessary to take characteristics of the financial products into account when user recommendation proportions of the financial products are determined.

Therefore, the embodiment of this application provides a method for assigning traffic to financial products. In this method, a wealth management platform constructs product recommendation features based on historical data of set parameters of the financial products, so as to obtain a comprehensive product recommendation feature of all of the financial products, then determines a user recommendation proportion of the financial product according to deviations of the product recommendation features of the financial products from the comprehensive product recommendation feature corresponding to the categories, and finally recommends the financial product to the user based on user recommendation proportions of the financial products. In this way, the set parameters are parameters of the financial products, which can reflect the characteristic of the financial product to a certain extent. Therefore, the user recommendation proportions that are determined based on the deviations of the product recommendation features constructed by the set of parameters from the comprehensive product recommendation feature of all products are directly related to the parameter of the financial products, and the user recommendation proportions of the financial products are determined by the characteristics of the products. For example, the corresponding user recommendation proportions may be determined based on advantages and disadvantages of the products, and a higher user recommendation proportion can be assigned to better financial products, so that more users can be assigned to better financial products, thereby improving the accuracy of recommending a financial product, and improving overall user experience. The user recommendation proportion related to the parameters of the financial products can be determined according to the parameters of the financial products, and the diversion of financial products is not affected by non-self parameters, thereby improving the stability of the wealth management platform and improving security of user data.

After a design idea of the embodiments of this application is described, the following describes application scenarios to which the technical solutions in the embodiments of this application can be applied. The application scenarios described below are merely used for describing rather than limiting the embodiments of this application. The technical solutions provided in the embodiments of this application may be flexibly applied as needed.

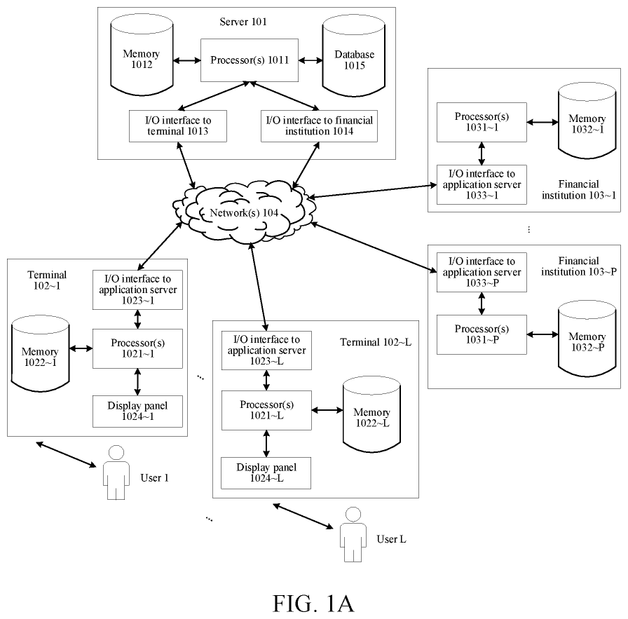

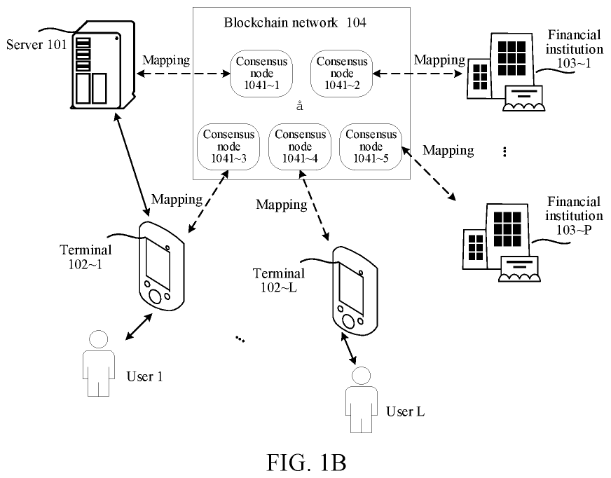

FIG. 1A is a schematic diagram of an applicable scenario according to an embodiment of the present disclosure. The scenario may include a server 101, a plurality of terminals 102 (a terminal 102-1 to a terminal 102-L that are exemplarily shown), and a plurality of financial institutions 103 (a financial institution 103-1 to a financial institution 103-P that are exemplarily shown). L and P are both positive integers, and values of L and P respectively represent a total number of users and financial institutions, which are not limited in the embodiments of this application.

The financial institution 103 may represent devices of the financial institutions, the financial institutions may provide one or more financial products, and the financial institution 103 may obtain income data of the financial products through calculation and store the data. The financial institution 103 may include one or more processors 1031, a memory 1032, and an I/O interface 1033 to a server. The processor 1031 may obtain income data of the financial products through calculation and store the data in the memory 1032. The income data of the financial products may further be transmitted to the server 101 through the I/O interface 1033 to the server.

The server 101 (a background server of the wealth management platform) may be an independent physical server, or may be a server cluster composed of a plurality of physical servers or a distributed system, and may further be a cloud server that provides cloud computing services. A cloud server (encapsulated with a program for recommending a financial product) is given by way of example. A user calls a financial product recommendation service in the cloud server through a terminal, so that the server deployed in the cloud calls the income data of the financial institution 103. The server calls the program recommended by encapsulated financial product, determines a proportion of the traffic assigned to the financial products, determines the financial product provided for the user according to the proportion, and pushes the financial product to the terminal to display the recommended financial product on a display interface of the terminal.

The server 101 may include one or more processors 1011, a memory 1012, an I/O interface 1013 to a terminal, an I/O interface 1014 to a financial institution, and the like. In addition, the server 101 may further be configured with a database 1015. The database 1015 may be configured to store user-related information such as user information, historical operation information, and the like of the users, and may further be configured to store information about a financial product provided by a financial institution, for example, income data, information related to the financial institution, and the like. The memory 1012 of the server 101 may store program instructions of the method for traffic assignment of the financial products provided in the embodiment of this application. The program instructions can be configured, when executed by the processor 1011, to implement the operations of the method for traffic assignment of the financial products provided in the embodiments of this application. In other words, the traffic assigned to the financial products provided by the financial institutions is determined according to the income data of the financial products, for example, a proportion of the traffic assigned to the financial product may be finally determined. In this way, when a new user is added to a financial platform, a financial product that needs to be presented to the new user may be determined based on the determined proportion, so as to control the traffic proportion of the financial product to maintain the above determined proportion.

The terminal 102 may be a terminal device such as a mobile phone, a personal computer (PC), a tablet computer, or the like. The terminal 102 may present a display page of a wealth management platform. For example, the terminal 102 may install an application (APP) provided by the wealth management platform to open the display page of the wealth management platform in the APP provided by the wealth management platform. Alternatively, the display page of the wealth management platform is presented through a browser on the terminal 102. Alternatively, the display page of the wealth management platform may be opened in other applications. Other applications refer to APPs provided by non-wealth management platforms. For example, the wealth management platform may exist in the APP as a light application, or the wealth management platform may serve as a function of the APP provided to users in the form of a mini app, an official account, a plug-in in WeChat, or the like.

The terminal 102 may include one or more processors 1021, a memory 1022, an I/O interface 1023 to the server 101, a display panel 1024, and the like. The memory 1022 of the terminal 102 may store program instructions for implementing the functions of the wealth management platform. Such program instructions can be configured to implement the functions of the wealth management platform when executed by the processor 1021, and display corresponding display pages of the wealth management platform on the display panel 1024.

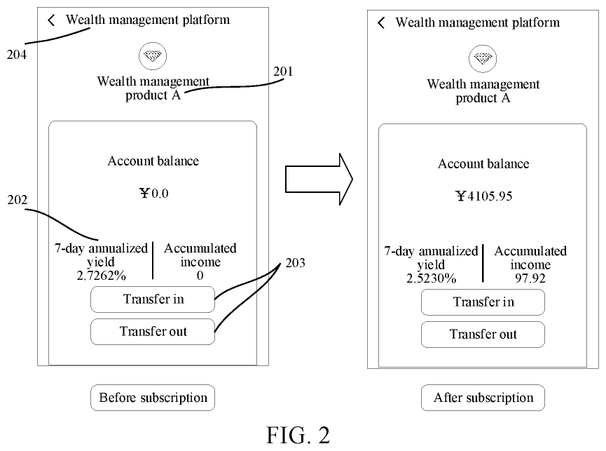

For example, when a new user registers an account of a wealth management platform and enters a page of the wealth management platform, the server 101 determines a financial product provided for the new user based on the predetermined traffic assignment of the financial products and pushes the financial product to the user, so that the user can view the financial product through the display interface of the wealth management platform. FIG. 2 is a schematic diagram of a display page of a wealth management platform. On a display page of the wealth management platform, a name 201 of the financial product assigned to the user may be viewed, which is a “wealth management product A” shown in FIG. 2, and income data 202 of the financial product may further be displayed. The user may determine whether to subscribe to the financial product according to its own situation. If so, a transfer may be initiated by operating a “transfer in” button in the button 203, to subscribe to the financial product. If not, the display interface is closed through a page jump button 204. When a new user is added to the wealth management platform, since the user has not subscribed to any financial product, an account balance displayed is zero when the display page of the wealth management platform is opened for the first time. However, when the user subscribes to a financial product, the account balance shown in the right picture of FIG. 2 is not zero, the income gradually increases with time, and the account balance and the amount of the accumulated income also increase. After subscription to a financial product, if the user needs to cash in circulated currency, a transfer-out may be initiated by operating a “transfer out” button in the button to implement conversion of financial products to currency.

Communication connections between the server 101 and the terminal 102 and between the server 101 and the financial institution 103 may be performed through one or more networks 104. The network 104 may be a wired network or a wireless network. For example, the wireless network may be a mobile cellular network, or may be a wireless fidelity (Wi-Fi) network, and may further be other possible networks, which is not limited in the embodiment of this application.

FIG. 1B is a schematic diagram of an applicable scenario according to an embodiment of the present disclosure, and FIG. 1B shows that the network 104 in FIG. 1A is a blockchain network (a consensus node 1041-1 to a consensus node 1041-5 that are exemplarily shown). A type of the blockchain network is flexible and may be, for example, any one of a public chain, a private chain, or a consortium chain. The public chain is used as an example. All electronic devices of any transaction entity, such as server 101 (a wealth management platform), a terminal 102, and a financial institution 103 can be connected to a blockchain network without authorization as consensus nodes of the blockchain. For example, the server 101 is mapped to the consensus node 1041-1 in the blockchain network, the financial institution 103-1 is mapped to the consensus node 1041-2 in the blockchain network, and the terminal 102-1 is mapped to the consensus node 1041-3 in the blockchain network. A consortium blockchain is used as an example. The electronic device under the transaction entity may be connected to the blockchain network after obtaining permission, for example, the server 101, the terminal 102, and the financial institution 103.

For example, when a user browses wealth management information on the terminal 102 (including a wealth management client), the terminal 102 initiates a request to recommend a financial product to the server 101 (the wealth management platform), and the server 101 is mapped to the consensus node 1041-1 in the blockchain network. The terminal 102 generates a transaction corresponding to an update operation according to the request to recommend the financial product. A smart contract that needs to be invoked to implement the update operation and parameters specified for the smart contract are specified in the transaction. The transaction further carries a digital certificate of the terminal 102 and a signed digital signature (for example, which are obtained by using a private key in the digital certificate of the terminal 102 to encrypt the summary of the transaction), and the transaction is transmitted to the consensus node in the blockchain network.

For example, when the server 101 (the consensus node 1041-1) receives the transaction, the digital certificate and the digital signature carried by the transaction are verified. After the verification is successful, it is determined, according to an identity carried in the transaction, whether the terminal 102 has transaction permission. A failure of any of the verification of the digital signature and permission causes a failure of the transaction. After the verification is successful, the digital signature of the node is signed (for example, obtained by using a private key of the consensus node 1041-1 to encrypt the summary of the transaction), a smart contract integrated with financial product recommendation is invoked to obtain a set of parameters of the financial product, a user recommendation proportion of the financial product is determined according to historical data of the set of parameters of the financial product, a financial product recommended to the user is determined according to the user recommendation proportions of the financial products, a transaction is generated according to the user recommendation proportion of the financial product and the financial product recommended to the user, and the transaction is transmitted to the consensus node in the blockchain network.

For example, when the financial institution 103-1 (the consensus node 1041-2) receives the transaction, a digital certificate and a digital signature carried in the transaction are verified. After the verification is successful, the digital signature of the node is signed (for example, obtained by using a private key of the consensus node 1041-2 to encrypt the summary of the transaction), and the signed transaction is transmitted to the consensus node in the blockchain network to continue the consensus.

When receiving the transaction again, the server 101 (a wealth management platform) continues to verify the digital certificate and the digital signature carried in the transaction. After the verification is successful, the digital signature of the node is signed, and the signed digital signature is returned to the client. When the client receives the transaction, the digital certificate and the digital signature carried in the transaction are verified. When the verification is successful and it is determined that a number of successful transactions through consensus exceeds a consensus threshold, reliability of the transaction result may be confirmed, that is, the user recommendation proportion of the financial product and the security of the financial product recommended to the user may be ensured.

Therefore, based on the characteristics of decentralization, distributed storage, and incapability of being tampered with, the user recommendation proportions of the financial products and the financial product recommended to the user are determined through the blockchain network, which can ensure fairness and transparency of computing, thereby ensuring the security of the wealth management platform, so that the user can perform safe shopping according to the recommended financial product.

Certainly, the method provided in the embodiment of this application is not limited to being used in the application scenarios shown in FIG. 1A to FIG. 1B, and may further be used in other possible application scenarios, which is not limited in the embodiment of this application. The functions that can be implemented by the devices in the application scenarios shown in FIG. 1A to FIG. 1B are to be described together in the subsequent method embodiments, and details are not described herein again.

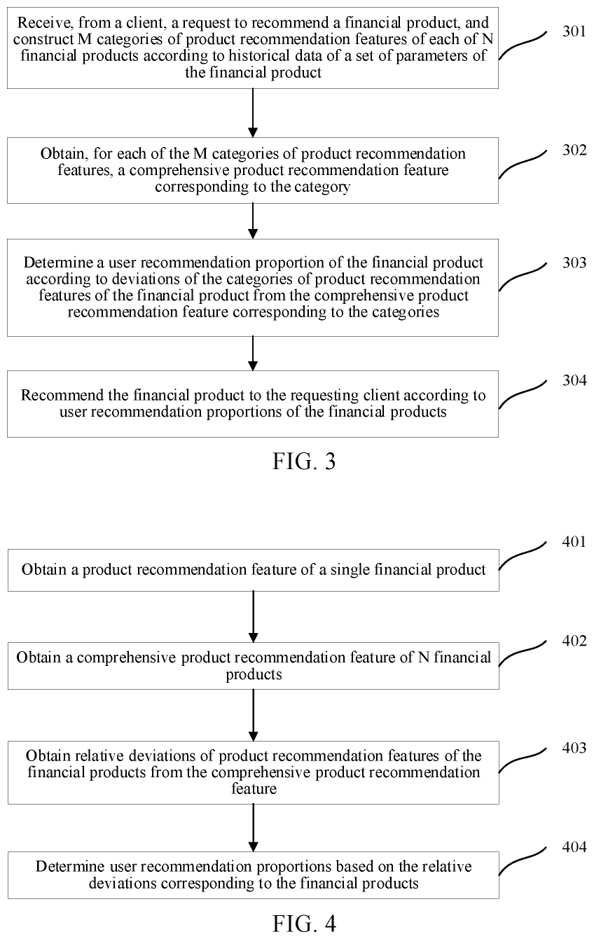

FIG. 3 is a schematic flowchart of a method for recommending a financial product according to an embodiment of this application. The method may be performed by an electronic device, for example, may be performed by the server in FIG. 1A.

Step 301: Receive, from a client, a request to recommend a financial product, and construct M categories of product recommendation features of each of N financial products according to historical data of a set of parameters of the financial product.

For example, when a user browses information related to financing on the client, the client automatically generates the request to recommend the financial product and transmits the request to recommend the financial product to the server. Upon receipt of the request to recommend the financial product, the server constructs M categories of product recommendation features of the financial product according to the historical data of the set of parameters of the financial product, so as to perform subsequent processing according to the product recommendation features.

In the embodiment of this application, there may be a plurality of financial products in the wealth management platform, and the N financial products may be all financial products in the wealth management products, or may be part of all of the financial products. For example, if the wealth management platform includes 5 financial products, then N financial products may be the 5 financial products. Alternatively, when one financial product A of the 5 financial products adopts a fixed user recommendation proportion, for example, the user recommendation proportion is ⅕, then N financial products may be the remaining 4 financial products except the financial product A, and a sum of the recommendation proportions of users to which the 4 financial products may further be assigned is 4/5.

For example, since users can generally subscribe to different types of financial products simultaneously, that is, different types of financial products generally do not cause competition issues between users, traffic assignment is generally for the same type of financial products.

In the embodiment of this application, the set of parameters may be any possible parameter of a financial product, for example, a financial product that focuses on incomes. The set parameter may be a yield rate, for example, a financial product that focuses on risks. The set parameter may be a risk rate, and the like. Since the user generally attaches more importance to the yield of the financial product when subscribing to a financial product, the set of parameters is the yield, for example, to describe the method for recommending a financial product of the embodiment of this application.

For example, for a financial product as a monetary fund, the yield may be ten thousand shares of incomes, a 7-day annualized yield, a 30-day annualized yield, or an annualized yield. However, for a financial product as a non-monetary fund, the yield may be an index such as an income in the last month, an income in the last three months, or the like.

For example, the yields of the financial products may be obtained through calculation by the wealth management platform according to the income data of the financial products. Alternatively, since the financial institutions collect statistics about indexes such as the yield of their own financial products, in order to prevent a deviation of the calculation method of the wealth management platform from the calculation of the financial institution at that time, the yield is different from the yield calculated by the financial institution. The wealth management platform may further directly obtain data such as the yield from the financial institution. In this way, a huge consumption of computing resources as a result of improper diversion calculations and a large number of users and a large amount of wealth management products can be avoided, which are error-prone, saving a certain number of calculations for the wealth management platform and reducing calculation pressure of the server. Since the yield is generally updated periodically, the server of the wealth management platform may periodically obtain the yield data from the financial institution. For example, if the yield is updated once a day, the server may obtain the data of the yield from the financial institution regularly every day. Alternatively, if the data of the yield is updated once a month, the server may obtain the data of the yield from the financial institution regularly every month.

For example, in addition to actively applying to the electronic device of the financial institution to obtain data of the yield to receive the data of the yield returned by the electronic device of the financial institution, the server may further adopt a method predetermined with the financial institution in which the electronic device of the financial institution provides the data of the yield to the server upon calculation of the yield. After the server obtains the data of the yield, the data of the yield may be stored in a unified manner, for example, stored in a database. The data of the yield is directly read from the database when required.

In the embodiment of this application, the server can respectively construct the M categories of product recommendation features of each of N financial products according to the historical data of the set of parameters of the financial product, N and M being both positive integers.

For example, the M categories of product recommendation features include at least one of the following features:

a mean value of the set of parameters within a first set time period, that is, an average yield;

a mean value of a rate of fluctuation of the set of parameters within a second set time period, that is, an average rate of fluctuation of incomes; and

a mean value of a combined feature within the second set time period, the combined feature being positively correlated with the set of parameters and being negatively correlated with the rate of fluctuation of the set parameter.

In some embodiments, the M categories of product recommendation features may be any of the above product recommendation features, or may be a combination of a plurality of categories of product recommendation features. However, no matter how many categories of product recommendation features there are, all of the processes of constructing product recommendation features are independent of each other.

For example, when the product recommendation feature is the mean value of the set of parameters within the first set time period, the first set time period is a statistical time period T₁ of the set parameter, and a length of T₁ may be set according to the situation. For example, the length may be last month, last two months, or the like, which is not limited in the embodiment of this application. For the financial product, the product recommendation feature of the financial product is constructed based on the historical data of the set of parameters of the financial product, and a mean value of the set of parameters of the financial product within the first set time period is obtained according to a data value of the set of parameters of the financial product within each of sub-time periods within the first set time period and a weight value corresponding to the sub-time period. For the financial product, the mean value of the set of parameters within the first set time period may be obtained in the above manner.

The weight value corresponding to the sub-time period may be configured to distinguish between a focus on long-term data and a focus on short-term data. For example, if the weight value is long-term data, the weight value within a sub-time period farther from the current time may be set to be larger. On the contrary, if the weight value is short-term data, a weight value within a sub-time period closer to the current time may be set to be larger.

For example, when the product recommendation feature is the mean value of the rate of fluctuation of the set of parameters within the second set time period, the second set time period is a statistical time period T₂ of the set parameter, and a length of T₂ may be the same as that of T₁ or may alternatively be different from that of T₁. Since the rate of fluctuation within a short time period may not be very large, the length of T₂ may be set to a longer time period, for example, may be set to last one month, last six months, last one year, or the like.

In order to obtain the mean value of the rate of fluctuation of the set of parameters within the second set time period, it is necessary to obtain rates of fluctuation of the financial products. For the financial product, the rate of fluctuation of the set of parameters of the financial product within the sub-time period may be obtained according to the data value of the set of parameters of the financial product within the sub-time period.

For example, the rate of fluctuation of the financial product represents the degree of change in the yield of the financial product. The rate of fluctuation may be obtained through the following process.

First, a rate of change in the data value of the set of parameters of the financial product within the sub-time period compared to the data value within a sub-time period prior to the sub-time period is obtained. For example, if a data value of the set of parameters within the sub-time period t₁ is A, and a data value of the set of parameters within the sub-time period t₂ prior to the sub-time period t₁ is B, the rate of change may be In (A/B).

Secondly, a deviation of the rate of change corresponding to the sub-time period of the financial product from the average rate of change within the second set time period is obtained. The average rate of change is the mean value of the rate of change within the second set time period, and the deviation may be represented by a variance or a standard deviation.

Finally, according to the deviation corresponding to the sub-time period of the financial product, the rate of fluctuation of the set of parameters of the financial product within the sub-time period is obtained. For example, if the deviation is expressed by a variance, then the rate of fluctuation may be expressed as a proportion of the variance to a square root of T₂.

In the embodiment of this application, after the rate of fluctuation of the financial product is obtained, the mean value of the rate of fluctuation of the set of parameters of the financial product within the second set time period may be obtained according to the rate of fluctuation of the set of parameters of the financial product within each of sub-time periods and a weight value corresponding to the sub-time period. For the financial product, the mean value of the rate of fluctuation of the set of parameters within the second set time period may be obtained in the above manner.

For example, when the product recommendation feature is the mean value of the combined feature within the second set time period, the combined feature may be a combination of the rate of fluctuation and the set parameter. For example, when the set of parameters is the yield, the rate of fluctuation of the yield may also be lower when the yield is continuously low, but the financial product with a lower yield is obviously not a better financial product. When the user recommendation proportion of the financial product is determined, in addition to considering the rate of fluctuation of the yield, the yield also needs to be considered, that is, the combined feature may be constructed based on the rate of fluctuation and the yield. The value of the combined feature may be positively correlated with the yield and is negatively correlated with the yield, which indicates that the financial product with a higher yield and a smaller rate of fluctuation is the better product.

For example, after the value of the combined feature within the sub-time periods is obtained according to the set parameters and the rates of fluctuation within the sub-time periods, the mean value of the combined features of the financial products within the second set time period may be obtained. Certainly, during calculation of the mean value, a weight value may alternatively be assigned to the sub-time period. For the method of assigning the weight value, reference may be made to the description of calculating the mean value of the set of parameters within the first set time period.

Step 302: Obtain, for each of the M categories of product recommendation features, a comprehensive product recommendation feature corresponding to the category.

In the embodiment of this application, the product recommendation feature is configured to represent a feature of one of N financial products, and the comprehensive product recommendation feature is configured to represent an overall feature of the N financial products.

For example, the comprehensive product recommendation feature may be represented by a mean value and a variance of the product recommendation feature. Then, after the product recommendation features of the financial products are obtained through the process of step 301, the comprehensive product recommendation feature of the N financial products may be obtained by calculating the mean value and the variance of the product recommendation features of the financial products.

Step 303: Determine a user recommendation proportion of the financial product according to deviations of the categories of product recommendation features of the financial product from the comprehensive product recommendation feature corresponding to the categories.

In the embodiment of this application, the user recommendation proportion is a proportion of users to which the financial product is recommended to all users.

For example, when the M categories of product recommendation features include only one of the above product recommendation features, the user recommendation proportion of the financial product may be determined according to the deviation of the product recommendation feature from the determined comprehensive product recommendation feature.

The deviation may refer to an absolute deviation, that is, a difference between mean values of the product recommendation feature of one financial product and the product recommendation features of the N financial products. Alternatively, the deviation may refer to a relative deviation, that is, a proportion of a value of the absolute deviation to a variance.

After the deviations corresponding to the financial products are obtained, the user recommendation proportions of the financial product may be obtained based on the deviations, the user recommendation proportions of the financial products being positively correlated with the deviations.

For example, when the M categories of product recommendation features include only a plurality of product recommendation features, user recommendation sub-proportions corresponding to the categories of product recommendation features may be obtained according to the deviations corresponding to the categories of product recommendation features of the financial products, and then a final user recommendation proportion is calculated according to user recommendation weights of the categories of product recommendation features. The process of obtaining the user recommendation sub-proportions corresponding to the categories of product recommendation features is the same as the calculation process described above when the M categories of product recommendation features include only one of the above product recommendation features. Therefore, reference may be made to the above description, and details are not described herein again.

For example, a sum of the user recommendation weights of the categories of product recommendation features is 100%, and therefore the user recommendation weights of the categories of product recommendation features may be obtained through an optimal solution process. Certainly, in some embodiments, fixed user recommendation weights may alternatively be set for the categories of product recommendation features, which is not limited in the embodiments of this application.

For example, the final user recommendation proportion is calculated by using formula (1):

fᵢ=Σⱼ₌₁^{M}ωⱼ*∅ᵢⱼ (1)

fᵢ represents a user recommendation proportion of the i^{th} financial product, ωⱼ represents a user recommendation weight of the j^{th} category of product recommendation feature, and ∅ᵢⱼ represents a user recommendation sub-proportion corresponding to the j^{th} category of product recommendation feature of the i^{th} financial product.

For example, during calculation of the user recommendation weight, the above calculation formula may be used as an objective function, and the sum of the user recommendation weights of the categories of product recommendation features being 100% may be used as a constraint condition to calculate an optimal user recommendation weight. Certainly, other conditions may further be added to the constraint condition, for example, the user recommendation proportions of all financial products are a fixed value.

For example, since the set of parameters may change with time, steps 301-303 in the embodiment of this application may be repeated for a plurality of times, for example, may be repeated periodically, or after a change value of the set of parameters is greater than or equal to a certain threshold, the user recommendation proportion is determined again. For example, when the set of parameters is a yield of the financial product, the yield is generally updated periodically, for example, once a day or once a month. Therefore, correspondingly, the user recommendation proportion may be determined once a day or once a month.

Step 304: Recommend a financial product to the requesting client according to user recommendation proportions of the financial products.

In the embodiment of this application, after the user recommendation proportions of the financial products are determined, the financial product may be recommended to the user based on the user recommendation proportions of the financial products.

Since a new user is added to the wealth management platform at an unfixed time, and after the new user is added to the wealth management platform, it is generally necessary to display the recommended financial product on a page of the wealth management platform. Therefore, the wealth management platform cannot uniformly assign the traffic of financial products based on existing users, and instead needs to recommend the financial product for the new user after the new user is added to the wealth management platform.

For example, the financial product is recommended to the user based on the determined user recommendation proportions of the financial products, so that a proportion of a number of users to which the financial products are recommended to all users is close to or the same as the user recommendation proportions of the financial products. The used user recommendation proportion is generally the user recommendation proportion obtained last time.

After the financial product recommended to the user is determined, the server may transmit, to the user, status data of the financial product recommended to the user. In this way, after the user, by using a user equipment, logs in with an account number corresponding to the user, the status data of the financial product recommended to the user can be displayed on a display page, for example, the display interface shown in FIG. 2. The status data may include data such as a name, a yield, a subscription condition of the user, an income condition of the user, and the like of the financial product.

The following will show several examples of obtaining a user recommendation proportion. The set parameter is the yield, for example.

As shown in FIG. 4, the process of determining the user recommendation proportion is described by using the product recommendation feature as the mean value of the yield within the first set time period as an example.

Step 401: Obtain a product recommendation feature of a single financial product.

In the embodiment of this application, the product recommendation feature is the mean value of the yield within the first set time period. The first set time period is a statistical time period T₁ of the set parameter, and a length of T₁ may be set according to the situation. For example, the length may be set to the last month, the last two months, or the like, which is not limited in the embodiment of this application.

For example, since an update cycle of the yield of the financial product is usually one day, a sub-time period may be set to one day, and the mean value of the set of parameters within the first set time period may be calculated by using formula (2):

$${r}_{i}^{avg} = \frac{Σφ ( t ) {r}_{i}^{t}}{Σφ ( t )} \qquad ( 2 )$$

rᵢ^{avg} represents a mean value of a yield of the i^{th} financial product within the first set time period, where i=1, 2, 3, . . . , N; rᵢ^{t} represents a yield of the i^{th} financial product within the t^{th} sub-time period, where t=1, 2, 3, . . . , T₁; and φ(t) represents a weight value corresponding to the t^{th} sub-time period, which is configured to distinguish between a focus on long-term data and a focus on short-term data. For example, if the weight value is the long-term data, the weight value within a sub-time period farther from the current time may be set to be larger. On the contrary, if the weight value is the short-term data, a weight value within a sub-time period closer to the current time may be set to be larger.

For example, when φ(t)=1, rᵢ^{avg} is a geometric mean value, that is, the weight within the sub-time period is equal. When φ(t)=t, and t=1, 2, 3, . . . , T₁, φ(t) is a linear weight, which means that a time closer to the current time indicates a larger weight value. Certainly, φ(t) may be other possible weight functions, for example, an exponential function or a logarithmic function, which is not limited in the embodiment of this application.

Through the above process of obtaining the product recommendation feature, the product recommendation features of all of the financial products may be obtained.

Step 402: Obtain a comprehensive product recommendation feature of N financial products.

In the embodiment of this application, the comprehensive product recommendation feature is the mean value and the variance of the product recommendation feature by way of example, the comprehensive product recommendation feature may be calculated by using formulas (3) and (4):

$$\begin{matrix}\overline{r} = \frac{1}{n} Σ {r}_{i}^{avg} & ( 3 ) \\ {δ}_{a} = \sqrt{\frac{1}{n - 1} {Σ ( \overline{r} - {r}_{i}^{avg} )}^{2}} & ( 4 )\end{matrix}$$

r̅ represents a mean value of the product recommendation features of N financial products, and δₐ represents a variance of the product recommendation features of the N financial products.

Certainly, in addition to using the mean value and the variance as the comprehensive product recommendation feature, the mean value and the standard deviation may further be used as the comprehensive product recommendation feature. Certainly, other possible adoption numbers may further be used as the comprehensive product recommendation feature, which is not limited in the embodiment of this application.

Step 403: Obtain relative deviations of the product recommendation features of the financial products from the comprehensive product recommendation feature.

In the embodiment of this application, the deviation herein is the relative deviation by way of example. The relative deviations of the product recommendation features of the financial products from the comprehensive product recommendation feature may be calculated by using formula (5):

$${k}_{ai} = \frac{{r}_{i}^{avg} - \overline{r}}{{δ}_{s}} \qquad ( 5 )$$

kₐᵢ represents the relative deviation of the product recommendation feature of the i^{th} financial product from the comprehensive product recommendation feature, where the subscript a indicates that the corresponding product recommendation feature is the mean value of the yield within T₁.

Step 404: Determine user recommendation proportions based on the relative deviations corresponding to the financial products.

In the embodiments of this application, it is easy to understand that a higher yield of the financial product indicates a larger value of the relative deviation corresponding to the financial product. In addition, when the yield of the financial product is higher, more traffic is to be assigned to the financial product, that is, the user recommendation proportion is to be higher. Therefore, a larger value of the relative deviation corresponding to the financial product indicates a higher user recommendation proportion of the financial product. In this way, the number of users to which the financial product can be assigned is larger, so that overall user experience can be improved, and stickiness of the users for the financial platform can be improved. Therefore, the user recommendation proportion may be calculated by using formula (6):

$${∅}_{ai} = \frac{1}{n} + α * {k}_{ai} * \frac{1}{n} \qquad ( 6 )$$

∅ₐᵢ represents a user recommendation proportion of the i^{th} financial product; α represents an assignment coefficient, α is configured to represent a proportion of total traffic that can be assigned, and α may be set to a fixed value or a variable value.

For example, the yields of the financial products may be high or low, and therefore a case that the relative deviation of the financial product is negative may occur. Therefore, in order to ensure the relative deviation to be the minimum, that is, traffic can be assigned to the financial product with the furthest negative deviation. In order to avoid excessive concentration of the traffic, a value of a may be set to a value that meets the following condition, as shown in formula (7):

$$α < \frac{1}{max ( \vert {k}_{ai} \vert )} \qquad ( 7 )$$

After the user recommendation proportions of the financial products are obtained based on the above calculation process, the financial product may be recommended to the user based on the user recommendation proportions of the financial products.

When the product recommendation feature is the mean value of the rate of fluctuation of the set of parameters within the second set time period, the process of calculating the user recommendation proportion is similar to the above process, that is, the product recommendation feature is replaced with a mean value of the rate of fluctuation of the set of parameters within the second set time period. Therefore, when the product recommendation feature is the mean value of the rate of fluctuation of the set of parameters within the second set time period, for the process of calculating the user recommendation proportion, reference may be made to the above description. Details are not described again in the embodiment of this application.

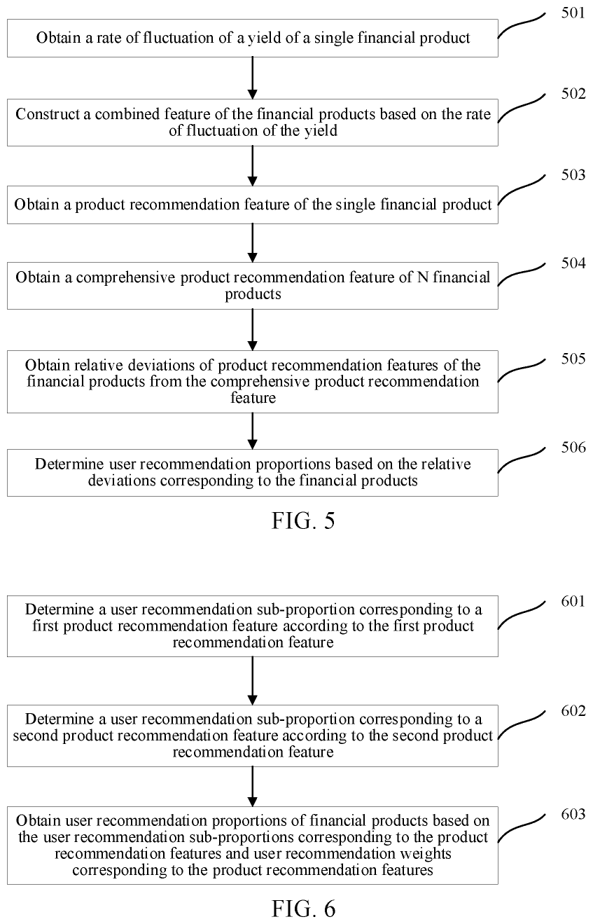

As shown in FIG. 5, the process of determining the user recommendation proportion is described by using the product recommendation feature as the mean value of the combined feature within the second set time period by way of example.

Step 501: Obtain a rate of fluctuation of a yield of a single financial product.

In the embodiment of this application, the product recommendation feature is the mean value of the combined feature within the second set time period. The second set time period is a statistical time period T₂ of the set parameter, and a length of T₂ may be set according to the situation. For example, the length may be set to last month, last six months, last one year, or the like, which is not limited in the embodiment of this application.

For example, the combined feature may be a combined feature composed of the yield and the rate of fluctuation of the yield. Therefore, before the mean value of the combined feature is obtained, the rates of fluctuation of the yields of the financial products need to be obtained first.

For example, for one financial product, during calculation of the rate of fluctuation of the yield, a relative change feature of the financial product may be constructed based on the yield of the financial product within the second set time period. The relative change feature may be calculated by using formula (8):

$${μ}_{i}^{t} = ln \frac{{r}_{i}^{t}}{{r}_{i}^{t - 1}} \qquad ( 8 )$$

μᵢ^{t} represents a rate of change of a data value of the i^{th} financial product within the t^{th} sub-time period compared to a data value within the (t-1)^{th} sub-time period, where t=1, 2, 3, . . . , T₂.

The rate of fluctuation of the yield within the second set time period may be understood as a dispersion degree of the rate of change within the second set time period. Therefore, a mean value and a variance of μᵢ^{t} may be calculated by using the following formulas (9) and (10):

$$\begin{matrix}\overline{μ} = \frac{1}{n} {\sum }_{t = 1}^{t + T} {μ}_{i}^{t} & ( 9 ) \\ {δ}_{c} = \sqrt{\frac{1}{n - 1} \sum {( \overline{μ} - {μ}_{i}^{t} )}^{2}} & ( 10 )\end{matrix}$$

μ̅ represents a mean value of μᵢ^{t} within the second set time period, and δ_{c} represents a variance of μᵢ^{t} within the second set time period.

Then, the rate of fluctuation of the yield of a financial product may be calculated by using formula (11):

$${τ}_{i}^{t} = \frac{{δ}_{c}}{\sqrt{{T}_{2}}} \qquad ( 11 )$$

τᵢ^{t} represents a rate of fluctuation of a yield of the i^{th} financial product within the t^{th} sub-time period. For the t^{th} sub-time period, the rate of fluctuation of the yield of the t^{th} sub-time period is calculated based on data from the t^{th} sub-time period to the T₂ sub-time periods prior to the t^{th} sub-time period. For example, if the statistical time period is half a year, then a rate of fluctuation on that day is calculated based on data on that day and within the half year prior to that day, and the rate of fluctuation of yesterday is calculated based on data of yesterday and within the half year prior to yesterday.

Step 502: Construct a combined feature of the financial products based on the rate of fluctuation of the yield.

In the embodiment of this application, when the yield is continuously low, the rate of fluctuation of the yield may also be lower, but the financial product with a lower yield is obviously not a better financial product. Therefore, when the user recommendation proportion of the financial product is determined, in addition to considering the rate of fluctuation of the yield, it is also necessary to consider the yield, that is, the combined feature may be constructed based on the rate of fluctuation and the yield. The value of the combined feature may be positively correlated with the yield and negatively correlated with the rate of fluctuation, which means that the financial product with a higher yield and a smaller rate of fluctuation is the better product. Therefore, the combined feature may be expressed by using formula (12):

ρᵢ^{t}=(1−τᵢ^{t})*rᵢ^{t} (12)

ρᵢ^{t} represents a combined feature of the i^{th} financial product within the t^{th} sub-time period. Certainly, the foregoing manner is only a manner of expressing the combined feature, and other possible manners that satisfy a rule of the above combined feature may further be adopted, which is not limited in the embodiment of this application.

Step 503: Obtain a product recommendation feature of the single financial product.

In the embodiment of this application, the product recommendation feature is the mean value of the combined feature within the second set time period. The mean value of the combined feature within the second set time period may be calculated by using formula (13):

$${ρ}_{i}^{avg} = \frac{Σφ ( t ) {ρ}_{i}^{t}}{Σφ ( t )} \qquad ( 13 )$$

ρᵢ^{avg} represents a mean value of the combined feature of the i^{th} financial product within the second set time period, where i=1, 2, 3, . . . , N.

For example, since the update cycle of the yield of the financial product is usually one day, a sub-time period may be set to one day.

φ(t) represents a weight value corresponding to the t^{th} sub-time period, which is configured to distinguish between a focus on long-term data and a focus on short-term data. For example, if the weight value is the long-term data, the weight value within a sub-time period farther from the current time may be set to be larger. On the contrary, if the weight value is the short-term data, a weight value within a sub-time period closer to the current time may be set to be larger.

For example, when φ(t)=1, ρᵢ^{avg} represents a geometric mean value, that is, the weight within the sub-time period is equal. When φ(t)=t, and t=1, 2, 3 . . . T₂, φ(t) is a linear weight, which means that a time closer to the current time indicates a larger weight value. Certainly, φ(t) may be other possible weight functions, for example, an exponential function or a logarithmic function, which is not limited in the embodiment of this application.

Through the above process of obtaining the product recommendation feature, the product recommendation features of all of the financial products may be obtained.

Step 504: Obtain a comprehensive product recommendation feature of N financial products.

In the embodiment of this application, the comprehensive product recommendation feature is the mean value and the variance of the product recommendation feature by way of example, the method of calculating the comprehensive product recommendation feature may be shown in formulas (14) and (15):

$$\begin{matrix}\overline{ρ} = \frac{1}{n} {Σρ}_{i}^{avg} & ( 14 ) \\ {δ}_{b} = \sqrt{\frac{1}{n - 1} {Σ ( \overline{r} - {r}_{i}^{avg} )}^{2}} & ( 15 )\end{matrix}$$

ρ̅ represents a mean value of the product recommendation features of N financial products, and δ_{b} represents a variance of the product recommendation features of the N financial products.

Certainly, in addition to using the mean value and the variance as the comprehensive product recommendation feature, the mean value and the standard deviation may further be used as the comprehensive product recommendation feature. Certainly, other possible adoption numbers may further be used as the comprehensive product recommendation feature, which is not limited in the embodiment of this application.

Step 505: Obtain relative deviations of the product recommendation features of the financial products from the comprehensive product recommendation feature.

In the embodiment of this application, the deviation herein is the relative deviation by way of example. The relative deviations of the product recommendation features of the financial products from the comprehensive product recommendation feature may be calculated by using formula (16):

$${k}_{bi} = \frac{{ρ}_{i}^{avg} - \overline{ρ}}{{δ}_{b}} \qquad ( 16 )$$

k_{bi} represents a relative deviation of the product recommendation feature of the i^{th} financial product from the comprehensive product recommendation feature, where the subscript b indicates that the corresponding product recommendation feature is the mean value of the combined feature within T₂.

Step 506: Determine user recommendation proportions based on the relative deviations corresponding to the financial products.

In the embodiments of this application, it is easy to understand that a higher yield of the financial product and a lower rate of fluctuation indicate a larger value of the combined feature and a larger value of the relative deviation corresponding to the financial product. In addition, when the yield of the financial product is higher and the rate of fluctuation is lower, more traffic is to be assigned to the financial product, that is, the user recommendation proportion is to be higher. Therefore, a larger value of the relative deviation corresponding to the financial product indicates a higher user recommendation proportion of the financial product. In this way, the number of users to which the financial product can be assigned is larger, so that overall user experience can be improved, and stickiness of the users for the financial platform can be improved. Therefore, the user recommendation proportion may be calculated by using formula (17):

$${∅}_{bi} = \frac{1}{n} + α * {k}_{bi} * \frac{1}{n} \qquad ( 17 )$$

∅_{bi} represents a user recommendation proportion of the i^{th} financial product; α represents an assignment coefficient, α is configured to represent a proportion of total traffic that can be assigned, and a may be set to a fixed value or a variable value.

For example, the yields of the financial products may be high or low, and therefore a case that the relative deviation of the financial product is negative may occur. Therefore, in order to ensure the relative deviation to be the minimum, that is, traffic can be assigned to the financial product with the furthest negative deviation. In order to avoid excessive concentration of the traffic, a value of a may be set to a value that meets the following condition, as shown in formula (18):

$$α < \frac{1}{max ( \vert {k}_{bi} \vert )} \qquad ( 18 )$$

After the user recommendation proportions of the financial products are obtained based on the above calculation process, the financial product may be recommended to the user based on the user recommendation proportions of the financial products.

As shown in FIG. 6, the product recommendation feature including the mean value of the yield within the first set time period and the mean value of the combined feature within the second set time period is given by way of example to describe the process of determining the user recommendation proportion. The mean value of the yield within the first time period is a first product recommendation feature, and the mean value of the combined feature within the second set time period is a second product recommendation feature.

Step 601: Determine a user recommendation sub-proportion corresponding to a first product recommendation feature according to the first product recommendation feature.

For the process of the step, reference may be made to description of steps 401-404. Details are not described herein again.

Step 602: Determine a user recommendation sub-proportion corresponding to a second product recommendation feature according to the second product recommendation feature.

For the process of the step, reference may be made to description of steps 501-506. Details are not described herein again. It is to be understood that there is no substantial sequence relationship between step 601 and step 602. In some embodiments, step 601 and step 602 may be performed simultaneously or sequentially. For example, step 601 is performed first, and then step 602 is performed, which is given by way of example in FIG. 6. Alternatively, step 602 is performed first, and then step 601 is performed.

Step 603: Obtain user recommendation proportions of financial products based on the user recommendation sub-proportions corresponding to the product recommendation features and user recommendation weights corresponding to the product recommendation features.

In the embodiment of this application, the user recommendation weights corresponding to the categories of product recommendation features may be fixed weights, or may be calculated through an optimal solution method.

For example, the user recommendation proportion may be calculated by using formulas (19) and (20):

fᵢ=ωₐ*∅ₐᵢ+ω_{b}*∅_{bi} (19)

ωₐ+ω_{b}=1 (20)

fᵢ represents a user recommendation proportion of the i^{th} financial product, ωₐ represents a user recommendation weight corresponding to the first product recommendation feature, ∅ₐᵢ represents a user recommendation sub-proportion corresponding to a first product recommendation feature of the i^{th} financial product, ω_{b} represents a user recommendation weight corresponding to a second product recommendation feature, and ∅_{bi} represents a user recommendation sub-proportion corresponding to the second product recommendation feature of the i^{th} financial product.

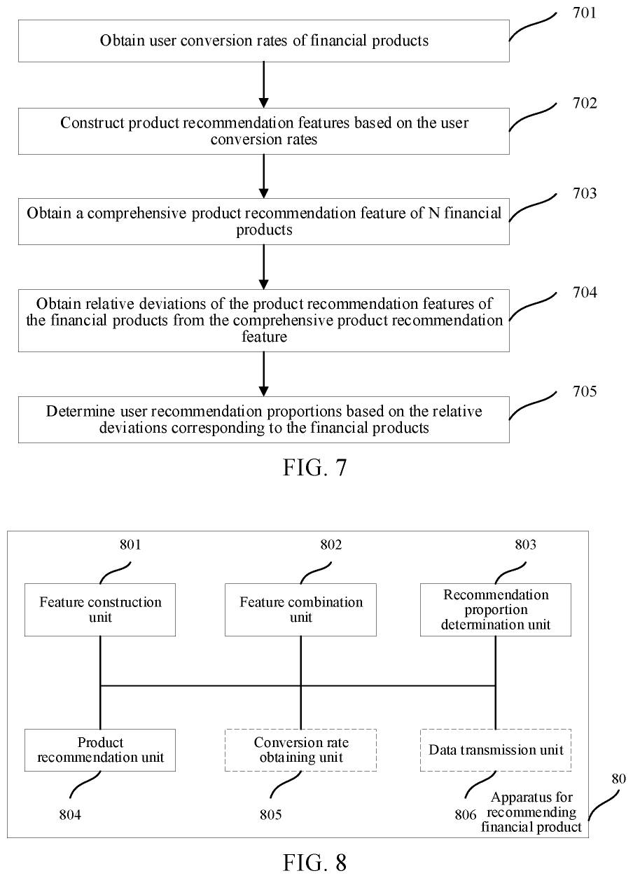

In the embodiments of this application, it is considered that after the financial product is recommended to the user, attractions of the financial products for users may be different, and the attractions are not only brought about by the yield or the stability of the yield, but also may be related to other factors of the financial products. For example, brand awareness of a financial product, popularity of a product manager, and the like may affect whether a user subscribes to a financial product. However, the attraction of the financial product may be measured by using a user conversion rate of the financial product. Therefore, in order to comprehensively consider other factors, the conversion rate of the financial products to the users may also be taken into consideration, that is, the user conversion rate may be combined with any of the above M categories of product recommendation features to construct a new combined product recommendation feature. As shown in FIG. 7, the mean values of the user conversion rate and the yield within the first set time period are combined by way of example below to describe the process of determining the user recommendation proportion.

Step 701: Obtain user conversion rates of the financial products.

The user conversion rate refers to a proportion of a number of users, in the users to which the financial product is recommended, that actually use the financial product to a total number of the users to which the financial product is recommended, and the user conversion rate may be calculated by using formula (21):

$${π}_{i} = \frac{{u}_{i}}{{f}_{i}} \qquad ( 21 )$$

πᵢ represents a user conversion rate of the i^{th} financial product, and uᵢ represents a proportion of a number of users that actually use the i^{th} financial product to all users. Certainly, in addition to using a proportion of the proportion of the number of users that use the i^{th} financial product to all users to the user recommendation proportion as the user conversion rate, a proportion of the number of users that actually use the i^{th} financial product to the number of users to which the i^{th} financial product is recommended may further be directly used as the user conversion rate.

Step 702: Construct product recommendation features based on the user conversion rates.

In the embodiment of this application, a higher user conversion rate and a higher yield indicate that the financial product is a better financial product. Therefore, the combined feature may be expressed by using the following formula (22):

Rᵢ^{avg}=πᵢ*rᵢ^{avg} (22)

Rᵢ^{avg} represents a combined product recommendation feature of the financial product that is constructed based on the user conversion rate and the average yield. Certainly, the foregoing manner is only a manner of expressing the combined product recommendation feature, and other possible manners that satisfy a rule of the above combined feature may further be adopted, which is not limited in the embodiment of this application.

Step 703: Obtain a comprehensive product recommendation feature of N financial products.

Step 704: Obtain relative deviations of the product recommendation features of the financial products from the comprehensive product recommendation feature.

Step 705: Determine user recommendation proportions based on the relative deviations corresponding to the financial products.

Steps 703-705 are similar to steps 402-404, or are similar to the process of steps 504-506. Therefore, for steps 703-705, reference may be made to the descriptions of steps 402-404 or steps 504-506, and the details are not described herein again.

Based on the above, in the embodiments of this application, product recommendation features are constructed based on historical data of set parameters of the financial products, so as to obtain a comprehensive product recommendation feature of all of the financial products, then a user recommendation proportion of the financial product is determined according to deviations of the product recommendation features of the financial products from the comprehensive product recommendation feature of corresponding to the categories, and finally the financial product is recommended to the user based on user recommendation proportions of the financial products. In this way, the set parameters are parameters of the financial products, which can reflect the characteristic of the financial product to a certain extent. Therefore, the user recommendation proportions that are determined based on the deviations of the product recommendation features constructed by the set of parameters from the comprehensive product recommendation feature of all products are directly related to the parameter of the financial products, and the user recommendation proportions of the financial products are determined by the characteristics of the products. For example, the corresponding user recommendation proportions may be determined based on advantages and disadvantages of the products, and a higher user recommendation proportion may be assigned to a better financial product, so that more users can be assigned to better financial products, thereby improving overall user experience.

Through the method for recommending a financial product of the embodiments of this application, not only the number of identical products may be limited to ensure potential financial risks, but also more traffic can be assigned to higher-quality financial products as much as possible, thereby improving the accuracy of recommendation and user experience. In addition, financial product providers may further be prevented from overstepping the traffic assignment strategy by raising a short-term income, so as to improve stability of the platform and guiding financial asset companies to provide users with better assets. In addition, use efficiency of platform traffic may further be improved in combination with the user conversion rate.

Referring to FIG. 8, based on the same inventive concept, an embodiment of this application further provides an apparatus 80 for recommending a financial product. The apparatus may be, for example, the server shown in FIG. 1A, and the apparatus includes:

a feature construction unit 801 configured to receive, from a client, a request to recommend the financial product, and construct M categories of product recommendation features of each of N financial products according to historical data of a set of parameters of the financial product, N and M being both positive integers;

a feature combination unit 802 configured to obtain, for each of the M categories of product recommendation features, a comprehensive product recommendation feature corresponding to the categories;

a recommendation proportion determination unit 803 configured to determine a user recommendation proportion of the financial product according to deviations of the categories of product recommendation features of the financial product from the comprehensive product recommendation feature corresponding to the categories, the user recommendation proportion being a proportion of users to which the financial product is recommended to all users; and

a product recommendation unit 804 configured to determine the recommended financial product according to user recommendation proportions of the financial products to the requesting client.

For example, the M categories of product recommendation features include at least one of the following features:

a mean value of the set of parameters within a first set time period;

a mean value of a rate of fluctuation of the set of parameters within a second set time period; and

a mean value of a combined feature within the second set time period, the combined feature being positively correlated with the set of parameters and being negatively correlated with the rate of fluctuation of the set parameter.

For example, the feature construction unit 801 is configured to: obtain the mean value of the set of parameters of the financial product within the first set time period according to a data value of the set of parameters of the financial product within each of sub-time periods within the first set time period and a weight value corresponding to the sub-time period.

For example, the feature construction unit 801 is configured to: obtain a rate of fluctuation of the set of parameters of the financial product within each of sub-time periods within the second set time period according to a data value of the set of parameters of the financial product within the sub-time period; and obtain the mean value of the rate of fluctuation of the set of parameters of the financial product within the second set time period according to the rate of fluctuation of the set of parameters of the financial product within the sub-time period and a weight value corresponding to the sub-time period.

For example, the feature construction unit 801 is configured to: obtain a rate of fluctuation of the set of parameters of the financial product within each of sub-time periods within the second set time period according to a data value of the set of parameters of the financial product within the sub-time period; construct the combined feature according to the set of parameters of the financial product and the rate of fluctuation of the set of parameters of the financial product within the sub-time period; and obtain the mean value of the combined feature of the financial product within the second set time period.

For example, the feature construction unit 801 is configured to: obtain a rate of change of the set of parameters of the financial product within the sub-time period compared to the data value within a sub-time period prior to the sub-time period; obtain a deviation of the rate of change of the financial product corresponding to the sub-time period from an average rate of change within the second set time period; and obtain the rate of fluctuation of the set of parameters of the financial product within the sub-time period according to the deviation of the financial product corresponding to the sub-time period.

For example, the recommendation proportion determination unit 803 is configured to: obtain the deviations of the categories of product recommendation features of the financial product from the comprehensive product recommendation feature corresponding to the categories; and determine the user recommendation proportion of the financial product according to the deviations corresponding to the categories of product recommendation features of the financial product. The user recommendation proportion of the financial product is positively correlated with the deviations.

For example, the recommendation proportion determination unit 803 is configured to: obtain user recommendation sub-proportions corresponding to the categories of product recommendation features according to the deviations corresponding to the categories of product recommendation features of the financial product; obtain user recommendation weights corresponding to the categories of product recommendation features of the financial product, a sum of the user recommendation weights corresponding to the categories of product recommendation features being 100%; and obtain the user recommendation proportion of the financial product according to the user recommendation sub-proportions corresponding to the categories of product recommendation features and the user recommendation weights corresponding to the categories of product recommendation features.

For example, the apparatus further includes a conversion rate obtaining unit 805 configured to obtain a user conversion rate of the financial product, the user conversion rate being a proportion of a number of users, in the users to which the financial product is recommended, that actually use the financial product to a total number of the users to which the financial product is recommended.

The feature construction unit 801 is further configured to obtain the mean value of the set of parameters of the financial product within the first set time period according to the historical data of the set of parameters of the financial product, and construct the product recommendation features of the financial product according to the mean value of the set of parameters of the financial product within the first set time period and the user conversion rate.

For example, the apparatus further includes a data transmission unit 806 configured to transmit, to the user, status data of the financial product recommended to the user, so that after the user, by using a user equipment, logs in with an account number corresponding to the user, the status data of the financial product recommended to the user is displayed on a display page of the user equipment, the status data including a name and a yield of the financial product.

The apparatus may be configured to perform the methods shown in the embodiments shown in FIG. 3 to FIG. 7. Therefore, for the functions that can be implemented by functional modules of the apparatus, reference may be made to the description of the embodiments shown in FIG. 3 to FIG. 7, and details are not described. The conversion rate obtaining unit 805 and the data transmission unit 806 are not mandatory functional units, which are shown with dashed lines in FIG. 8.

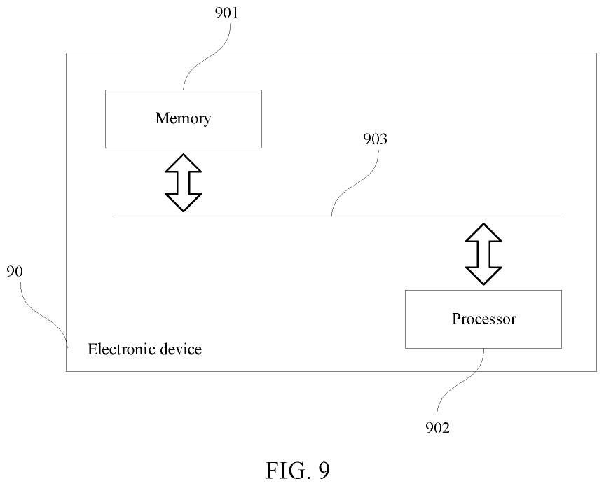

Referring to FIG. 9, based on the same technical concept, an embodiment of this application further provides an electronic device 90, which may include a memory 901 and a processor 902.

The memory 901 is configured to store a computer program executed by the processor 902. The memory 901 may mainly include a program storage area and a data storage area. The program storage area may store an operating system, an application program that is required by at least one function, and the like. The data storage area may store data created according to use of the electronic device, and the like. The processor 902 may be a central processing unit (CPU), a digital processing unit, or the like. In this embodiment of this application, a connection medium between the memory 901 and the processor 902 is not limited. In this embodiment of this application, in FIG. 9, the memory 901 and the processor 902 are connected to each other through a bus 903. The bus 903 is represented by using a bold line in FIG. 9. A manner of connection between other components is only schematically described, but is not used as a limitation. The bus 903 may be classified into an address bus, a data bus, a control bus, or the like. For ease of representation, only one thick line is used to represent the bus in FIG. 9, but this does not mean that there is only one bus or only one type of bus.

The memory 901 may be a volatile memory, such as a random-access memory (RAM). The memory 901 may alternatively be a non-volatile memory, such as a read-only memory, a flash memory, a hard disk drive (HDD), or a solid-state drive (SSD). Alternatively, the memory 901 is any other medium that may be used for carrying or storing expected program code having an instruction or data structure form, and that may be accessed by a computer, but is not limited thereto. The memory 901 may be a combination of the foregoing memories.

The processor 902 is configured to invoke a computer program stored in the memory 901 to perform the method performed by the devices in the embodiments shown from FIG. 3 to FIG. 7.

In some possible implementations, each aspect of the method provided in this application may be further implemented in a form of a program product including program code. When the program product is run on an electronic device, the program code is used to enable the electronic device to perform steps of the method according to the categories of exemplary implementations of this application described above in the specification. For example, the electronic device can perform the method performed by the devices in the embodiments shown from FIG. 3 to FIG. 7.

The program product may use any combination of one or more computer-readable storage media. The computer-readable storage medium may be a readable signal medium or a readable storage medium. The readable storage medium may be, for example, but is not limited to, an electric, magnetic, optical, electromagnetic, infrared, or semi-conductive system, apparatus, or device, or any combination thereof. For example, examples of readable storage media (non-exhaustive list) include: electrical connections with one or more wires, portable disks, hard disks, random access memory (RAM), personal read memory (ROM), erasable Programmable readable memory (EPROM or flash memory), optical fiber, portable compact disk personal read memory (CD-ROM), optical storage device, magnetic storage device, or any suitable combination of the above.

Although preferable embodiments of this application have been described, once persons skilled in the technology know a basic creative concept, they can make other changes and modifications to these embodiments. Therefore, the following claims are intended to be construed as to cover the exemplary embodiments and all changes and modifications falling within the scope of this application.

Obviously, a person skilled in the art can make various modifications and variations to this application without departing from the spirit and scope of this application. In this case, if the modifications and variations made to this application fall within the scope of the claims of this application and their equivalent technologies, this application is intended to include these modifications and variations.

### INDUSTRIAL APPLICABILITY

In the embodiments of this application, product recommendation features are constructed by using a server according to the historical data of the set parameters of the financial products, a comprehensive product recommendation feature of all of the financial products is obtained, then the user recommendation proportion of the financial product is determined according to the deviations of the product recommendation features of the financial products from the comprehensive product recommendation feature corresponding to the categories, and a financial product is recommended to a user according to user recommendation proportions of the financial products. In this way, according to the parameters of the financial products, the user recommendation proportion related to the parameters of the financial product can be determined, which improves the accuracy of diverting the financial products and the security of user data.

What is claimed is:

1. A method for recommending a financial product performed by a server and comprising:
receiving, from a client, a request to recommend the financial product;
constructing M categories of product recommendation features of each of N financial products according to historical data of a set of parameters of the financial product, N and M being both positive integers;
obtaining, for each of the M categories of product recommendation features, a comprehensive product recommendation feature corresponding to the category;
determining a user recommendation proportion of the financial product according to deviations of the categories of product recommendation features of the financial product from the comprehensive product recommendation feature corresponding to the categories, the user recommendation proportion being a proportion of users to which the financial product is recommended to all users; and
determining the recommended financial product according to user recommendation proportions of the financial products to the requesting client.

2. The method according to claim 1, wherein the M categories of product recommendation features comprise at least one of the following features:
a mean value of the set of parameters within a first set time period;
a mean value of a rate of fluctuation of the set of parameters within a second set time period; and
a mean value of a combined feature within the second set time period, the combined feature being positively correlated with the set of parameters and being negatively correlated with the rate of fluctuation of the set parameter.

3. The method according to claim 2, wherein the constructing M categories of product recommendation features of each of N financial products according to historical data of a set of parameters of the financial product comprises:
obtaining the mean value of the set of parameters of the financial product within the first set time period according to a data value of the set of parameters of the financial product within each of sub-time periods within the first set time period and a weight value corresponding to the sub-time period.

4. The method according to claim 2, wherein the constructing M categories of product recommendation features of each of N financial products according to historical data of a set of parameters of the financial product comprises:
obtaining a rate of fluctuation of the set of parameters of the financial product within each of sub-time periods within the second set time period according to a data value of the set of parameters of the financial product within the sub-time period; and
obtaining the mean value of the rate of fluctuation of the set of parameters of the financial product within the second set time period according to the rate of fluctuation of the set of parameters of the financial product within the sub-time period and a weight value corresponding to the sub-time period.

5. The method according to claim 2, wherein the constructing M categories of product recommendation features of each of N financial products according to historical data of a set of parameters of the financial product comprises:
obtaining a rate of fluctuation of the set of parameters of the financial product within each of sub-time periods within the second set time period according to a data value of the set of parameters of the financial product within the sub-time period; and
constructing the combined feature according to the set of parameters of the financial product and the rate of fluctuation of the set of parameters of the financial product within the sub-time period; and
obtaining the mean value of the combined feature of the financial product within the second set time period.

6. The method according to claim 4, wherein the obtaining a rate of fluctuation of the set of parameters of the financial product within each of sub-time periods within the second set time period according to a data value of the set of parameters of the financial product within the sub-time period comprises:
obtaining a rate of change of the set of parameters of the financial product within the sub-time period compared to the data value within a sub-time period prior to the sub-time period;
obtaining a deviation of the rate of change of the financial product corresponding to the sub-time period from an average rate of change within the second set time period; and
obtaining the rate of fluctuation of the set of parameters of the financial product within the sub-time period according to the deviation of the financial product corresponding to the sub-time period.

7. The method according to claim 1, wherein the determining a user recommendation proportion of the financial product according to deviations of the categories of product recommendation features of the financial product from the comprehensive product recommendation feature corresponding to the categories comprises:
obtaining the deviations of the categories of product recommendation features of the financial product from the comprehensive product recommendation feature corresponding to the categories; and
determining the user recommendation proportion of the financial product according to the deviations corresponding to the categories of product recommendation features of the financial product, the user recommendation proportion of the financial product being positively correlated with the deviations.

8. The method according to claim 7, wherein the determining the user recommendation proportion of the financial product according to the deviations corresponding to the categories of product recommendation features of the financial product comprises:
obtaining user recommendation sub-proportions corresponding to the categories of product recommendation features according to the deviations corresponding to the categories of product recommendation features of the financial product;
obtaining user recommendation weights corresponding to the categories of product recommendation features of the financial product, a sum of the user recommendation weights corresponding to the categories of product recommendation features being 100%; and
obtaining the user recommendation proportion of the financial product according to the user recommendation sub-proportions corresponding to the categories of product recommendation features and the user recommendation weights corresponding to the categories of product recommendation features.

9. The method according to claim 1, further comprising:
obtaining a user conversion rate of the financial product, the user conversion rate being a proportion of a number of users, in the users to which the financial product is recommended, that actually use the financial product to a total number of the users to which the financial product is recommended; and
the constructing M categories of product recommendation features of each of N financial products according to historical data of a set of parameters of the financial product comprises:
obtaining the mean value of the set of parameters of the financial product within the first set time period according to the historical data of the set of parameters of the financial product, and constructing the product recommendation features of the financial product according to the mean value of the set of parameters of the financial product within the first set time period and the user conversion rate.

10. The method according to claim 1, further comprising:
after determining the recommended financial product according to the user recommendation proportion of the financial product:
transmitting, to the requesting client, status data of the financial product recommended to the requesting client, so that after the requesting client, by using a user equipment, logs in with an account number corresponding to the requesting client, the status data of the financial product recommended to the requesting client is displayed on a display page of the user equipment, the status data comprising a name and a yield of the financial product.

11. An electronic device, comprising a memory and a processor,
the memory being configured to store a plurality of computer programs, and
the processor, when executing the plurality of computer programs, being configured to perform a plurality of operations including:
receiving, from a client, a request to recommend the financial product;
constructing M categories of product recommendation features of each of N financial products according to historical data of a set of parameters of the financial product, N and M being both positive integers;
obtaining, for each of the M categories of product recommendation features, a comprehensive product recommendation feature corresponding to the category;
determining a user recommendation proportion of the financial product according to deviations of the categories of product recommendation features of the financial product from the comprehensive product recommendation feature corresponding to the categories, the user recommendation proportion being a proportion of users to which the financial product is recommended to all users; and
determining the recommended financial product according to user recommendation proportions of the financial products to the requesting client.

12. The electronic device according to claim 11, wherein the M categories of product recommendation features comprise at least one of the following features:
a mean value of the set of parameters within a first set time period;
a mean value of a rate of fluctuation of the set of parameters within a second set time period; and
a mean value of a combined feature within the second set time period, the combined feature being positively correlated with the set of parameters and being negatively correlated with the rate of fluctuation of the set parameter.

13. The electronic device according to claim 12, wherein the constructing M categories of product recommendation features of each of N financial products according to historical data of a set of parameters of the financial product comprises:
obtaining the mean value of the set of parameters of the financial product within the first set time period according to a data value of the set of parameters of the financial product within each of sub-time periods within the first set time period and a weight value corresponding to the sub-time period.

14. The electronic device according to claim 12, wherein the constructing M categories of product recommendation features of each of N financial products according to historical data of a set of parameters of the financial product comprises:
obtaining a rate of fluctuation of the set of parameters of the financial product within each of sub-time periods within the second set time period according to a data value of the set of parameters of the financial product within the sub-time period; and
obtaining the mean value of the rate of fluctuation of the set of parameters of the financial product within the second set time period according to the rate of fluctuation of the set of parameters of the financial product within the sub-time period and a weight value corresponding to the sub-time period.

15. The electronic device according to claim 12, wherein the constructing M categories of product recommendation features of each of N financial products according to historical data of a set of parameters of the financial product comprises:
obtaining a rate of fluctuation of the set of parameters of the financial product within each of sub-time periods within the second set time period according to a data value of the set of parameters of the financial product within the sub-time period; and
constructing the combined feature according to the set of parameters of the financial product and the rate of fluctuation of the set of parameters of the financial product within the sub-time period; and
obtaining the mean value of the combined feature of the financial product within the second set time period.

16. The electronic device according to claim 14, wherein the obtaining a rate of fluctuation of the set of parameters of the financial product within each of sub-time periods within the second set time period according to a data value of the set of parameters of the financial product within the sub-time period comprises:
obtaining a rate of change of the set of parameters of the financial product within the sub-time period compared to the data value within a sub-time period prior to the sub-time period;
obtaining a deviation of the rate of change of the financial product corresponding to the sub-time period from an average rate of change within the second set time period; and
obtaining the rate of fluctuation of the set of parameters of the financial product within the sub-time period according to the deviation of the financial product corresponding to the sub-time period.

17. The electronic device according to claim 11, wherein the determining a user recommendation proportion of the financial product according to deviations of the categories of product recommendation features of the financial product from the comprehensive product recommendation feature corresponding to the categories comprises:
obtaining the deviations of the categories of product recommendation features of the financial product from the comprehensive product recommendation feature corresponding to the categories; and
determining the user recommendation proportion of the financial product according to the deviations corresponding to the categories of product recommendation features of the financial product, the user recommendation proportion of the financial product being positively correlated with the deviations.

18. The electronic device according to claim 17, wherein the determining the user recommendation proportion of the financial product according to the deviations corresponding to the categories of product recommendation features of the financial product comprises:
obtaining user recommendation sub-proportions corresponding to the categories of product recommendation features according to the deviations corresponding to the categories of product recommendation features of the financial product;
obtaining user recommendation weights corresponding to the categories of product recommendation features of the financial product, a sum of the user recommendation weights corresponding to the categories of product recommendation features being 100%; and
obtaining the user recommendation proportion of the financial product according to the user recommendation sub-proportions corresponding to the categories of product recommendation features and the user recommendation weights corresponding to the categories of product recommendation features.

19. The electronic device according to claim 11, wherein the plurality of operations further comprise:
obtaining a user conversion rate of the financial product, the user conversion rate being a proportion of a number of users, in the users to which the financial product is recommended, that actually use the financial product to a total number of the users to which the financial product is recommended; and
the constructing M categories of product recommendation features of each of N financial products according to historical data of a set of parameters of the financial product comprises:
obtaining the mean value of the set of parameters of the financial product within the first set time period according to the historical data of the set of parameters of the financial product, and constructing the product recommendation features of the financial product according to the mean value of the set of parameters of the financial product within the first set time period and the user conversion rate.

20. A non-transitory computer-readable storage medium storing a plurality of computer programs that, when executed by a processor of an electronic device, cause the electronic device to perform a plurality of operations including:
receiving, from a client, a request to recommend the financial product;
constructing M categories of product recommendation features of each of N financial products according to historical data of a set of parameters of the financial product, N and M being both positive integers;
obtaining, for each of the M categories of product recommendation features, a comprehensive product recommendation feature corresponding to the category;
determining a user recommendation proportion of the financial product according to deviations of the categories of product recommendation features of the financial product from the comprehensive product recommendation feature corresponding to the categories, the user recommendation proportion being a proportion of users to which the financial product is recommended to all users; and
determining the recommended financial product according to user recommendation proportions of the financial products to the requesting client.
